(19) United States
(12) Patent Application Publication
(10) Pub. No.: US 2017/0198863 A1
(43) Pub. Date: Jul. 13, 2017

(54) HEAT INSULATOR AND HEAT-INSULATING VESSEL

(71) Applicant: Panasonic Intellectual Property Management Co., Ltd., Osaka (JP)

(72) Inventor: TSUYOKI HIRAI, Shiga (JP)

(21) Appl. No.: 15/314,685

(22) PCT Filed: Jun. 2, 2015
(86) PCT No.: PCT/JP2015/002774

§ 371 Date: Nov. 29, 2016

(30) Foreign Application Priority Data
Jun. 4, 2014 (JP) 2014-115448

(51) Int. Cl. F17C 3/04; F16L 59/14; F17C 3/08

(52) U.S. Cl. CPC F17C 3/04; F17C 3/08; F16L 59/14; F17C 2221/033; F17C 2270/0105; F17C 2203/0636; F17C 2205/0335; F17C 2260/042

(57) ABSTRACT

A heat insulator (10) is provided in a heat-insulating vessel for holding a substance having a temperature that is lower than ordinary temperature by at least 100° C. The heat insulator (10) includes a core material (14) and an outer wrapping material (13) for wrapping the core material (14). The core material (14) has a heat-insulating core material made of an open-cell resin. The outer wrapping material (13) is made of a metal thin plate. A peripheral edge of the metal thin plate is fixedly bonded. An inside of the outer wrapping material is vacuum-sealed.

### TECHNICAL FIELD

The present invention relates to a heat insulator and a heat-insulating vessel for holding a substance having a temperature that is lower than ordinary temperature by at least 100° C., such as a liquefied natural gas or a hydrogen gas.

### BACKGROUND ART

Generally, a combustible gas such as a natural gas or a hydrogen gas is in a gaseous state at ordinary temperature. For this reason, at a time of storage or transportation, these combustible gases are liquefied and held in a heat-insulating vessel.

To take a natural gas as an example of the combustible gas, a representative example of a heat-insulating vessel for holding a liquefied natural gas (LNG) is a tank such as an LNG tank disposed on land or a tank of an LNG transportation tanker, or the like. It is necessary that these LNG tanks hold an LNG at a temperature that is at least 100° C. lower than ordinary temperature (the temperature of the LNG is typically −162° C.), and therefore, it is demanded that the heat-insulating performance is enhanced as much as possible.

A vacuum heat insulator is known as a material having a high heat insulation property. A general vacuum heat insulator is formed by enclosing a fibrous core material made of an inorganic material in a reduced-pressure sealed state into an inside of a bag-shaped outer wrapping material having a gas barrier property. A field in which this vacuum heat insulator is used may be, for example, home electric appliances such as a household refrigerator, industrial refrigerating equipment, or a heat-insulating wall for housing.

When such a vacuum heat insulator is applied to a heat-insulating vessel such as an LNG tank, it is expected that penetration of heat into the heat-insulating vessel is effectively suppressed. When penetration of heat can be suppressed in the LNG tank, generation of a boil off gas (BOG) can be effectively reduced. In addition, natural vaporization rate (boil off rate, BOR) of an LNG can be effectively lowered. An example in which a vacuum heat insulator is applied to an LNG tank may be a heat-insulating structure of a low-temperature tank disclosed in PTL 1.

A laminate including a thermally welded layer and a gas barrier layer is used as the outer wrapping material of the vacuum heat insulator. A representative gas barrier layer may be, for example, an aluminum vapor deposition layer. Such a laminate has effective durability as long as the laminate is used in the field of home electric appliances or housing.

In contrast, in the field of LNG tanks and others, for example, the vacuum heat insulator may possibly be exposed to a severer environment than in the field of home electric appliances or housing. In such a severe environment, higher durability is demanded in the vacuum heat insulator, particularly in the outer wrapping material.

For example, the vacuum heat insulator of the LNG transportation tanker is required to have performance of being capable of enduring even when a ship body of the tanker is destroyed to let sea water penetrate into the inside on a basis of “International Code for the Construction and Equipment of Ships Carrying Liquefied Gases in Bulk” (IGC code). For example, salts contained in sea water, such as sodium chloride, are known as substances that promote corrosion of aluminum. For this reason, when the vacuum heat insulator is exposed to sea water, there is a fear that the outer wrapping material (laminate including a gas barrier layer made of an aluminum vapor deposition layer) may be corroded. In addition, when the outer wrapping material is corroded to cause bag breakage or destruction, a reduced-pressure state in the inside of the vacuum heat insulator cannot be maintained, and moreover, there is a fear that the sea water that has penetrated into the inside may come into contact with the core material to corrode the core material.

However, in the field of heat-insulating vessels such as an LNG tank, use of a vacuum heat insulator as a heat-insulating material is little known, though known to such a degree that a technique disclosed in PTL 1 is found out.

FIG. 5 is a schematic cross-sectional view illustrating a heat-insulating structure of a conventional inboard tank. In FIG. 5, reference numeral 201 denotes a tank outer wall, and reference numeral 202 denotes several thousand sheets of heat-insulating panels arranged on an outside of tank outer wall 201. Heat-insulating panels 202 include inner-layer panel 203 made of a phenolic foam and outer-layer panel 204 obtained by wrapping surroundings of vacuum heat insulator 204a (one obtained by vacuum-packing of glass wool serving as the core material with a multilayer laminate film) with hard polyurethane foam 204b. Reference numeral 205 denotes an additional heat-insulating panel disposed on the outside of joint 206 between adjacent heat-insulating panels 202 so as to cover joint 206. In a same manner as in outer-layer panel 204, heat-insulating panel 205 is produced by wrapping surroundings of vacuum heat insulator 205a with hard polyurethane foam 205b.

According to the conventional configuration, flow of heat from an inner wall side of the tank toward the outer wall is blocked out by vacuum heat insulators 204a, 205a that are alternately arranged in addition to inner-layer panel 203 and hard polyurethane foam 204b of outer-layer panel 204. For this reason, heat-insulating performance of the low-temperature tank can be remarkably improved.

However, along with destruction or the like of the ship body of the tanker, cracks are generated, and the sea water penetrates into an outer circumferential part of vacuum heat insulators 204a, 205a, so that the vacuum heat insulators are exposed to the sea water. This leaves a fear that hard polyurethane foam 205b and hard polyurethane foam 204b that cover vacuum heat insulator 205a and vacuum heat insulator 204a, respectively, may undergo bag breakage or destruction by corrosion of the outer wrapping material (laminate including the gas barrier layer) as described above.

For this reason, in order to apply the vacuum heat insulator to the heat-insulating vessel, it is demanded that the durability of the vacuum heat insulator is further improved.

### CITATION LIST

### Patent Literature

PTL 1; Unexamined Japanese Patent Publication No. 2010-249174

### SUMMARY OF THE INVENTION

The present invention has been made in view of these points, and an object thereof is to provide a thermal insulator that enhances durability against sea water or the like.

The present invention is a heat insulator provided in a heat-insulating vessel for holding a substance having a temperature that is lower than ordinary temperature by at least 100° C. The heat insulator includes a core material and an outer wrapping material for wrapping the core material. The core material has a heat-insulating core material made of an open-cell resin. The outer wrapping material is made of a metal thin plate; a peripheral edge of the metal thin plate is fixedly bonded; and an inside of the outer wrapping material is vacuum-sealed.

This allows that the outer wrapping material of the metal thin plate that vacuum-seals the core material has outstandingly higher corrosion resistance performance than the gas barrier layer made of the aluminum vapor deposition layer does, so that, even when the outer wrapping material is exposed to sea water, the outer wrapping material is prevented from bag breakage or destruction by being corroded. Therefore, the durability of the outer wrapping material can be maintained at a high level over a long period of time. In addition, because the metal thin plate constituting the outer wrapping material has rigidity, the outer wrapping material can have not only durability against sea water and the like but also durability (shock resistance) against a severe environment at a time of production, physical shock, and the like. Moreover, because the open-cell resin constituting the heat-insulating core material contributes to improvement of physical properties of the outer wrapping material, such as strength and rigidity, the durability of the outer wrapping material considerably increases also because the outer wrapping material is made of the metal thin plate. Therefore, reliability can be greatly improved.

The present invention can provide a heat insulator having high durability against exposure to sea water. In addition, the present invention can advantageously provide an effective technique as a heat insulator of a heat-insulating vessel that holds a substance such as an LNG or a hydrogen gas at a low temperature.

### BRIEF DESCRIPTION OF DRAWINGS

FIG. 1A is a schematic view illustrating a schematic configuration of an LNG transportation tanker provided with an inboard tank which is a heat-insulating vessel according to a first exemplary embodiment of the present invention.

FIG. 1B is a schematic view illustrating a schematic configuration of the inboard tank corresponding to a 1B-1B cross-sectional view of FIG. 1A.

FIG. 2 is an illustrative view illustrating a double-layer structure of an inner surface of the inboard tank shown in FIG. 1B.

FIG. 3 is a schematic cross-sectional view illustrating a vacuum heat insulator used in the inboard tank shown in FIG. 1A, FIG. 1B, and FIG. 2.

FIG. 4A is a schematic cross-sectional view illustrating one example of an explosion-proof structure of a vacuum heat insulator according to a second exemplary embodiment of the present invention.

FIG. 4B is a schematic plan view illustrating another example of the explosion-proof structure of the vacuum heat insulator according to the second exemplary embodiment of the present invention.

FIG. 5 is a schematic cross-sectional view illustrating a heat-insulating structure of a conventional inboard tank.

### DESCRIPTION OF EMBODIMENTS

Hereinafter, preferable exemplary embodiments of the present invention will be described with reference to drawings. In the following, same or corresponding elements will be denoted with same reference numerals all through the drawings, and duplicated description thereof will be omitted.

### First Exemplary Embodiment

[Inboard Tank as Heat-Insulating Vessel]

In the present exemplary embodiment, description will be given by giving, as one representative example of a heat-insulating vessel, an inboard tank for an LNG that is disposed in an LNG transportation tanker.

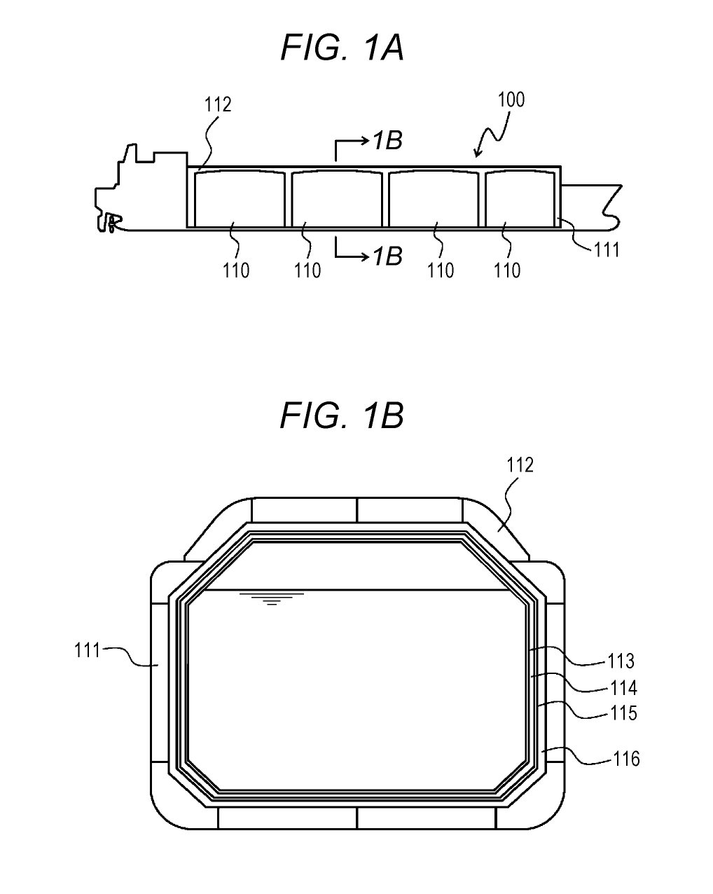

FIG. 1A is a schematic view illustrating a schematic configuration of an LNG transportation tanker provided with an inboard tank which is a heat-insulating vessel according to the first exemplary embodiment of the present invention. FIG. 1B is a schematic view illustrating a schematic configuration of the inboard tank corresponding to a 1B-1B cross-sectional view of FIG. 1A.

Referring to FIG. 1A, LNG transportation tanker 100 in the present exemplary embodiment is a tanker of a membrane system and includes a plurality of inboard tanks 110 (a total of four tanks in FIG. 1A). The plurality of inboard tanks 110 are arranged in a line along a longitudinal direction of ship body 111. Referring to FIG. 1B, an inside of each inboard tank 110 is an inside space for storing (holding) a liquefied natural gas (LNG) (fluid holding space). In addition, most of inboard tanks 110 are externally supported by ship body 111, and an upper part of inboard tanks 110 is sealed with deck 112.

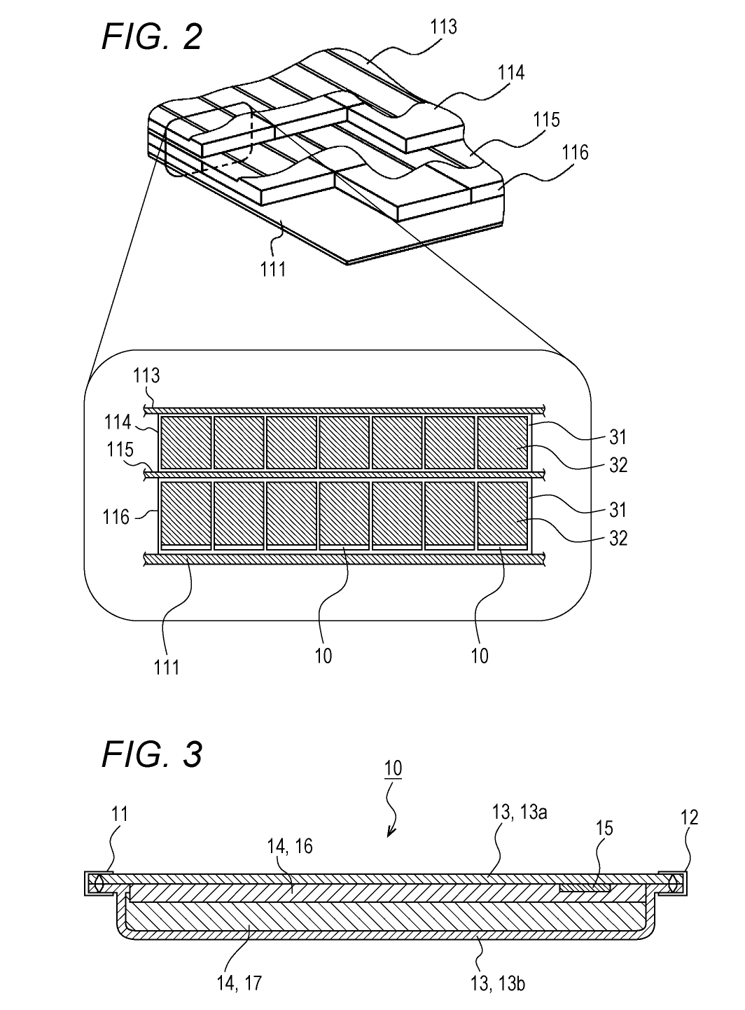

FIG. 2 is an illustrative view illustrating a double-layer structure of an inner surface of the inboard tank shown in FIG. 1B, and shows a schematic perspective view and a partially enlarged cross-sectional view thereof. Referring to FIG. 1B and FIG. 2, primary membrane 113, primary heat-proof box 114, secondary membrane 115, and secondary heat-proof box 116 are laminated in this order from an inside toward an outside on an inner surface of inboard tank 110. This allows that a double “heat-insulating tank structure” is formed on the inner surface of inboard tank 110. The “heat-insulating tank structure” as referred to herein indicates a structure including a layer of a heat-proof material (heat-insulating material) and a membrane made of metal. Primary membrane 113 and primary heat-proof box 114 constitute a “heat-insulating tank structure” on an inner side. Secondary membrane 115 and secondary heat-proof box 116 constitute a “heat-insulating tank structure” on an outer side.

The heat-proof material prevents (or suppresses) penetration of heat from an outside of inboard tank 110 into an inside space. In the present exemplary embodiment, the heat-proof material is used as primary heat-proof box 114 and secondary heat-proof box 116. A specific configuration of primary heat-proof box 114 and secondary heat-proof box 116 is not particularly limited. However, referring to FIG. 2, a representative example may be a configuration in which an inside of box body 31 made of wood is filled with foam 32 such as perlite. The heat-proof material is not limited to a heat-insulating box, and other known heat-proof materials or heat-insulating materials may be used.

The membrane functions as a “tank” for holding an LNG in the inside space so that the LNG may not leak out. In use, the membrane covers the heat-proof material. In the present exemplary embodiment, primary membrane 113 covering (disposed inside of) primary heat-proof box 114 and secondary membrane 115 covering (disposed inside of) secondary heat-proof box 116 are used. A specific configuration of primary membrane 113 and secondary membrane 115 is not particularly limited. However, a metal film of stainless steel, a nickel alloy (invar), or the like may be mentioned as a representative example.

Both of primary membrane 113 and secondary membrane 115 are members that prevent an LNG from leaking out. However, primary membrane 113 and secondary membrane 115 do not have a strength that maintains the structure as inboard tank 110. Inboard tank 110 is supported by ship body 111 and deck 112. In other words, leaking-out of an LNG from inboard tank 110 is prevented by primary membrane 113 and secondary membrane 115. A load of an LNG is supported by ship body 111 via primary heat-proof box 114 and secondary heat-proof box 116. Therefore, when inboard tank 110 is seen as a heat-insulating vessel, ship body 111 corresponds to a “vessel box body”.

In the present exemplary embodiment, in the double “heat-insulating tank structure”, secondary heat-proof box 116 located at an outermost side is provided with heat-insulator 10 as shown in FIG. 2. In an example shown in FIG. 2, heat-insulator 10 is located on a back side of a surface that is within secondary heat-proof box 116 and on an outside as viewed from inboard tank 110.

[Configuration of Heat Insulator]

FIG. 3 is a schematic cross-sectional view illustrating a vacuum heat insulator used in the inboard tank shown in FIG. 1A, FIG. 1B, and FIG. 2. Referring to FIG. 3, heat insulator 10 is formed to be what is known as a vacuum heat insulator by vacuum-sealing core material 14 and gas adsorption material 15 within outer wrapping material 13. Hereinafter, heat insulator 10 will be referred to as vacuum heat insulator 10. Herein, vacuum-sealing includes a state in which a pressure in the inside of outer wrapping material 13 is lower than atmospheric pressure.

Outer wrapping material 13 of vacuum heat insulator 10 is made of a metal thin plate having high corrosion resistance, such as stainless steel or a metal having an ionization tendency equivalent to or lower than that of stainless steel. A thickness of the metal thin plate is set to be at least 0.3 mm. In this exemplary embodiment, outer wrapping material 13 is made of a stainless steel thin plate having a thickness of 0.3 mm. Outer wrapping material 13 is formed by welding 11 a peripheral edge of thin flat plate 13a and a peripheral edge of thin concave plate 13b together, covering a resulting welded portion with cover 12, and vacuum-sealing an inside, and has rigidity in itself.

In addition, in this exemplary embodiment, core material 14 that is vacuum-sealed by outer wrapping material 13 is made of a heat-insulating core material having two layers. First heat-insulating core material 16 which is one of the two layers is made of an open-cell resin of thermosetting type. Second heat-insulating core material 17 which is the other one of the two layers is made of a fiber material.

The open-cell resin constituting first heat-insulating core material 16 is an open-cell resin such as open-cell urethane disclosed in Japanese Patent No. 5310928 of the present applicant. Description of a detailed structure of the open-cell resin will be omitted by making reference to the description of Japanese Patent No. 5310928; however, a brief description thereof is as follows.

That is, the open-cell resin is, for example, an open-cell urethane foam formed by copolymerization reaction, which fills the inside of core material 14 by integrated foaming. Numerous cells that are present in a core layer at a central part of core material 14 are in communication with each other through a first through-hole. Further, cells that are present in a skin layer near an interface with the metal thin plate of outer wrapping material 13 are in communication with each other through a second through-hole formed by a powder having a lower affinity to urethane resin. The cells in a whole region extending from the core layer to the skin layer are formed as the open-cell resin whose cells are in communication with each other by the first through-hole and the second through-hole.

In the open-cell resin having the aforementioned structure, for example, in the open-cell urethane foam, according as a void ratio thereof increases, a vacuum volume increases, and simultaneously, a surface area in the inside of the open-cell urethane foam increases. Heat from the outside propagates along a surface of this open-cell urethane foam, so that a heat insulation property is improved by increase in the surface area of the open-cell urethane foam. Therefore, by using this open-cell resin disclosed in Japanese Patent No. 5310928, closed cells that remain in the skin layer near an inner surface of the box body are turned into open cells, and the vacuum volume and the surface area of the open-cell resin increase, so that the heat insulation property is higher than that of a general closed-cell type urethane foam.

Furthermore, the open-cell resin constituting first heat-insulating core material 16 retains a shape of vacuum heat insulator 10 by supporting outer wrapping material 13 of vacuum heat insulator 10, thereby contributing to an improvement in the physical properties such as strength and rigidity of the vacuum heat insulator. According as the void ratio increases, the heat insulation property of the open-cell resin is improved; however, a shape-retaining force decreases. Therefore, the void ratio of the open-cell resin may be determined by taking the heat insulation property and the mechanical strength into consideration. In this exemplary embodiment, the cells have a size ranging from 30 μm to 200 μm (both inclusive), and the void ratio is within a range from 95% to 99% (both inclusive).

In addition, second heat-insulating core material 17 is made of a fiber material that is conventionally often used. For second heat-insulating core material 17, an inorganic fiber material in particular is adopted from a viewpoint of improvement in fire retardancy or the like. Specifically, for example, a glass wool fiber, a ceramic fiber, a slag wool fiber, a rock wool fiber, or the like is adopted. In the present exemplary embodiment, a glass wool fiber having an average fiber diameter within a range from 4 μm to 10 μm (both inclusive) (glass fiber having a comparatively large fiber diameter) is used, and further is fired for use.

In addition, the fiber material constituting second heat-insulating core material 17 is enclosed in a gas-permeable wrapping bag material (not illustrated in the drawings), and is formed to have a shape that goes along the shape of outer wrapping material 13. In other words, when a binder material is mixed in the fiber material, the fiber material can be more effectively made to have a shape that goes along the shape of a space for heat insulation. Even in that case, a percentage of the fiber material is set so that the fiber material accounts for at least 5% to 90% (both inclusive).

Further, as to vacuum heat insulator 10 configured in a manner as described above, first heat-insulating core material 16 is disposed to be located on an inside space side of primary membrane 113 and second heat-insulating core material 17 is disposed to face toward an outside. First heat-insulating core material 16 has a higher heat insulation property according as a temperature lowers. In the inside space, a substance such as an LNG is stored.

[Functions and Effects of Vacuum Heat Insulator]

Next, functions and effects of vacuum heat insulator 10 configured in the above manner will be described.

In vacuum heat insulator 10, outer wrapping material 13 that vacuum-seals core material 14 is made of a metal thin plate (thin flat plate 13a and thin concave plate 13b) made of stainless steel. A metal thin plate made of stainless steel has outstandingly higher corrosion resistance performance than a gas barrier layer made of an aluminum vapor deposition layer. Therefore, even when the outer wrapping material is exposed to sea water, the outer wrapping material is prevented from bag breakage or destruction by being corroded, and the durability of the outer wrapping material can be maintained at a high level over a long period of time.

Therefore, use of vacuum heat insulator 10 as a heat-insulating material of an inboard tank allows that, even when outer wrapping material 13 that vacuum-seals core material 14 is exposed to sea water, the outer wrapping material is prevented from bag breakage or destruction by being corroded. Therefore, the reliability of vacuum heat insulator 10 is enhanced.

In addition, outer wrapping material 13 made of a metal thin plate has rigidity. Therefore, the outer wrapping material can have not only durability against sea water and the like but also durability (shock resistance) against a severe environment at a time of production, physical shock, and the like.

In particular, in vacuum heat insulator 10, one of heat-insulating core material 16 and second heat-insulating core material 17 that is vacuum-sealed by outer wrapping material 13 is an open-cell resin and, as already described, the open-cell resin retains the shape of vacuum heat insulator 10 by supporting outer wrapping material 13, that is, improves physical properties such as strength and rigidity of vacuum heat insulator 10. Therefore, even when an external force is applied by destruction of a tanker ship body, fall during a production process, or the like, vacuum heat insulator 10 can escape from destruction and the like owing also to a fact that outer wrapping material 13 is made of the metal thin plate. Therefore, vacuum heat insulator 10 has enhanced reliability.

In addition, because the open-cell urethane foam used as the open-cell resin is a thermosetting resin, durability against thermal change is also enhanced. The open-cell resin constituting the core material undergoes little deformation even when there is, for example, a temperature change accompanying a transition from a day time to night time, or an extreme temperature change that is generated in a case of an LNG transportation tanker or the like that moves from an extremely hot area to an extremely cold area. Therefore, generation of an inconvenience by thermal deformation can be prevented.

In addition, in vacuum heat insulator 10, core material 14 that is vacuum-sealed by outer wrapping material 13 is a double-layer core material including first heat-insulating core material 16 made of an open-cell resin and second heat-insulating core material 17 made of a fiber material. Therefore, in vacuum heat insulator 10, the combined heat-insulating performance of first heat-insulating core material 16 and second heat-insulating core material 17 enhances the heat-insulating performance of vacuum heat insulator 10.

Core material 14 has a double-layer structure including first heat-insulating core material 16 made of an open-cell resin and second heat-insulating core material 17 made of a fiber material such as glass wool. Therefore, the heat-insulating effects of first heat-insulating core material 16 and second heat-insulating core material 17 are synergized, so that the heat-insulating performance of vacuum heat insulator 10 is enhanced. Therefore, in secondary heat-proof box 116 containing vacuum heat insulator 10, an amount of foam 32 that fills an inside thereof, such as perlite, can be reduced, and the thickness of secondary heat-proof box 116 itself can be reduced. The volume of the heat-insulating vessel can be increased accordingly.

In addition, the heat insulation property of the vacuum heat insulator is generally affected by an amount of gas that is present in the outer wrapping material, so that the amount of gas released from the core material is preferably as small as possible. However, in the open-cell resin and the like, the gas remaining in the cell resin tends be released along with lapse of time.

However, in the present exemplary embodiment, core material 14 has two layers including first heat-insulating core material 16 made of an open-cell resin and second heat-insulating core material 17 made of a fiber material, so that the thickness of first heat-insulating core material 16 made of the open-cell resin can be reduced. This allows that the gas itself that gradually comes out from the inside of the open-cell resin can be reduced. Therefore, decrease of the heat-insulating performance can be suppressed. In addition, first heat-insulating core material 16 disperses the gas over to a whole passageway made of the open cell. This allows that deformation caused by local pressure rise can also be suppressed.

In addition, in the open-cell resin constituting first heat-insulating core material 16, the cell thereof has a small size ranging from 30 μm to 200 μm (both inclusive). For this reason, when the space for heat insulation is vacuumized, gas permeation resistance (gas discharge resistance) of the open-cell resin is large, so that it takes a lot of time to reduce a pressure in an inside space of the open-cell resin.

However, as described above, in the present exemplary embodiment, first heat-insulating core material 16 of vacuum heat insulator 10 has a thickness that is reduced by an amount equal to the thickness of second heat-insulating core material 17. Therefore, by this reduction of thickness, the open-cell passageway of the open-cell resin constituting first heat-insulating core material 16 can be shortened, and the gas permeation resistance can be reduced. Therefore, the time for vacuumization can be shortened to provide improved productivity, and vacuum heat insulator 10 can be provided at a lower price.

In addition, vacuum heat insulator 10 can be obtained by pouring an open-cell resin in a state in which second heat-insulating core material 17 made of a fiber material is placed in an inside of outer wrapping material 13 having rigidity, and subjecting a resultant product to integral foaming and vacuumization. Therefore, productivity can be greatly improved as compared with a case in which a core material is put into an outer wrapping material made of a flexible laminate sheet bag that does not have a shape-retaining property. Therefore, production costs can be reduced, and vacuum heat insulator 10 can be provided at a further lower price.

In addition, the fiber material constituting second heat-insulating core material 17 is enclosed in a gas-permeable wrapping bag material. For this reason, the fiber material having flexibility and being liable to lose shape can be easily put into outer wrapping material 13. Therefore, productivity can be further improved to achieve cost reduction. In addition, even when the shape of vacuum heat insulator 10 is complex, the fiber material can be disposed following this shape, and can be used for a heat-insulating structure having a complex shape.

In addition, in the present exemplary embodiment, gas adsorption material 15 is vacuum-sealed together with core material 14 in vacuum heat insulator 10. Therefore, decrease of heat insulation property, deformation, and the like caused by the gas released from the open-cell resin can be suppressed with certainty, and a vacuum heat insulator of high quality can be provided. In other words, the gas contained in the open-cell resin constituting first heat-insulating core material 16 and is gradually released and the gas remaining in second heat-insulating core material 17 are adsorbed by gas adsorption material 15. As a result of this, internal pressure rise caused by the gas can be suppressed with certainty, and deformation of vacuum heat insulator 10 is prevented. Simultaneously, deterioration of the heat insulation property caused by the gas is suppressed, and a good heat insulation property can be maintained for a long period of time. In particular, in the present exemplary embodiment, gas adsorption material 15 is disposed on a side of the open-cell resin constituting first heat-insulating core material 16, so that the gas that is released from this open-cell resin with lapse of time can be efficiently adsorbed via the open-cell passageway. Therefore, prevention of internal pressure rise and suppression of decrease in the heat insulation property can be efficiently carried out, and high heat-insulating performance can be maintained.

In addition, as described above, gas adsorption material 15 adsorbs a mixture gas of water vapor, air, and the like that remains in or penetrates into the sealed space such as outer wrapping material 13. Gas adsorption material 15 is not particularly designated; however, a chemical adsorption substance such as calcium oxide or magnesium oxide, a physical adsorption substance such as zeolite, or a mixture of the chemical adsorption substance and the physical adsorption substance can be used. In addition, as gas adsorption material 15, it is possible to use a copper ion-exchanged ZSM-5 type zeolite having high adsorption performance and a large adsorption volume that has both a chemical adsorption property and a physical adsorption property.

In the present exemplary embodiment, an adsorption material containing a copper ion-exchanged ZSM-5 type zeolite is used as gas adsorption material 15. For this reason, even when an open-cell resin having a tendency such that the gas continues to be released with lapse of time is used as the core material, gas adsorption can be continued with certainty over a long period of time by the high adsorption performance and the large adsorption volume of the copper ion-exchanged ZSM-5 type zeolite. Therefore, prevention of internal pressure rise and suppression of decrease in the heat insulation property in vacuum heat insulator 10 can be carried out with certainty over a long period of time.

Further, the fiber material constituting second heat-insulating core material 17 is an inorganic fiber material such as glass wool or rock wool, and thus, an amount of moisture generated from the fiber material can be kept small, and a good heat insulation property can be maintained. In other words, an inorganic fiber has a low water absorption property (moisture absorption property) in itself, so that a water content in the inside of vacuum heat insulator 10 can be kept low. This allows that decrease in the adsorption capability of gas adsorption material 15 caused by moisture adsorption can be suppressed. Therefore, gas adsorption material 15 can be made to exhibit a good gas adsorption function to provide a good heat-insulating performance.

In addition, the inorganic fiber is fired. Therefore, even when vacuum heat insulator 10 is broken due to an influence of some sort, the fiber material does not expand largely, and the shape of vacuum heat insulator 10 can be retained. For example, when the inorganic fiber is sealed without being fired, expansion at a time of breakage of vacuum heat insulator 10 can be two or three times as large as that before breakage, though depending on various conditions. In contrast, by firing the inorganic fiber, the expansion at the time of breakage can be suppressed to be within 1.5 times as large as that before breakage. For this reason, the expansion at the time of breakage can be effectively suppressed, and a dimension retaining property can be enhanced.

Further, as to vacuum heat insulator 10 used as a heat-insulating material of this inboard tank, first heat-insulating core material 16 is disposed to be located on an inside space side of primary membrane 113. Therefore, heat insulation can be made more efficiently, and the heat insulation property of vacuum heat insulator 10 can be enhanced. The heat insulation property is enhanced according as first heat-insulating core material 16 has a lower temperature. The inside space stores a substance such as an LNG. In other words, by adopting the aforementioned construction, first heat-insulating core material 16 having a lower thermal conductivity X first performs heat insulation strongly on the inside space having a low temperature. Then, second heat-insulating core material 17 located on an outside of first heat-insulating core material 16 performs heat insulation on the inside space in a low-temperature region having a comparatively higher temperature after the heat insulation is strongly made by first heat-insulating core material 16 having the lower thermal conductivity X. Therefore, even second heat-insulating core material 17 having a little higher thermal conductivity X can perform heat insulation strongly. Therefore, an extremely low-temperature substance in the vessel can be stored under heat insulation efficiently by making use of the individual heat insulation properties of first heat-insulating core material 16 and second heat-insulating core material 17. In particular, this is effective in the case in which the substance that is stored in primary membrane 113 constituting the tank is a substance having an extremely low temperature of −162° C. such as an LNG, for example.

As described above, heat insulator 10 of the present exemplary embodiment is a heat insulator provided in heat-insulating vessel 110 for holding a substance having a temperature that is lower than ordinary temperature by at least 100° C. In addition, heat insulator 10 includes core material 14 and outer wrapping material 13 for wrapping core material 14. In addition, core material 14 has a heat-insulating core material corresponding to first heat-insulating core material 16 made of an open-cell resin. In addition, outer wrapping material 13 is made of a metal thin plate corresponding to thin flat plate 13a and thin concave plate 13b; the peripheral edge of the metal thin plate is fixedly bonded; and the inside of outer wrapping material 13 is vacuum-sealed.

This allows that outer wrapping material 13 of the metal thin plate that vacuum-seals core material 14 has outstandingly higher corrosion resistance performance than the gas barrier layer made of the aluminum vapor deposition layer does, so that, even when the outer wrapping material is exposed to sea water, the outer wrapping material is prevented from bag breakage or destruction by being corroded. Therefore, the durability of the outer wrapping material can be maintained at a high level over a long period of time. In addition, because the metal thin plate constituting outer wrapping material 13 has rigidity, the outer wrapping material can have not only durability against sea water and the like but also durability (shock resistance) against a severe environment at a time of production, physical shock, and the like. Moreover, because the open-cell resin constituting the heat-insulating core material contributes to improvement of physical properties such as strength and rigidity of outer wrapping material 13, the durability of the outer wrapping material considerably increases also because the outer wrapping material is made of the metal thin plate. Therefore, reliability can be greatly improved.

In addition, the open-cell resin may be a thermosetting resin. This allows that the open-cell resin constituting core material 14 undergoes little deformation even when there is a temperature change accompanying a transition from a day time to night time, or an extreme temperature change that is generated in a case of an LNG transportation tanker or the like that moves from an extremely hot area to an extremely cold area. Therefore, generation of an inconvenience by thermal deformation can be prevented.

In addition, the open-cell resin may be an open-cell urethane foam, an open-cell phenolic foam, or a copolymer resin containing the open-cell urethane foam or the open-cell phenolic foam. This allows that a heat insulator having high durability can be provided.

In addition, outer wrapping material 13 may be made of stainless steel or a metal having an ionization tendency equivalent to or lower than that of the stainless steel. This allows that the corrosion of outer wrapping material 13 when outer wrapping material 13 is exposed to sea water can be effectively prevented, and the durability of outer wrapping material 13 can be improved.

### Second Exemplary Embodiment

The second exemplary embodiment is an embodiment in which, when a residual gas expands in the inside of outer wrapping material 13 of vacuum heat insulator 10, sudden and rapid deformation of vacuum heat insulator 10 can be suppressed or prevented with more certainty.

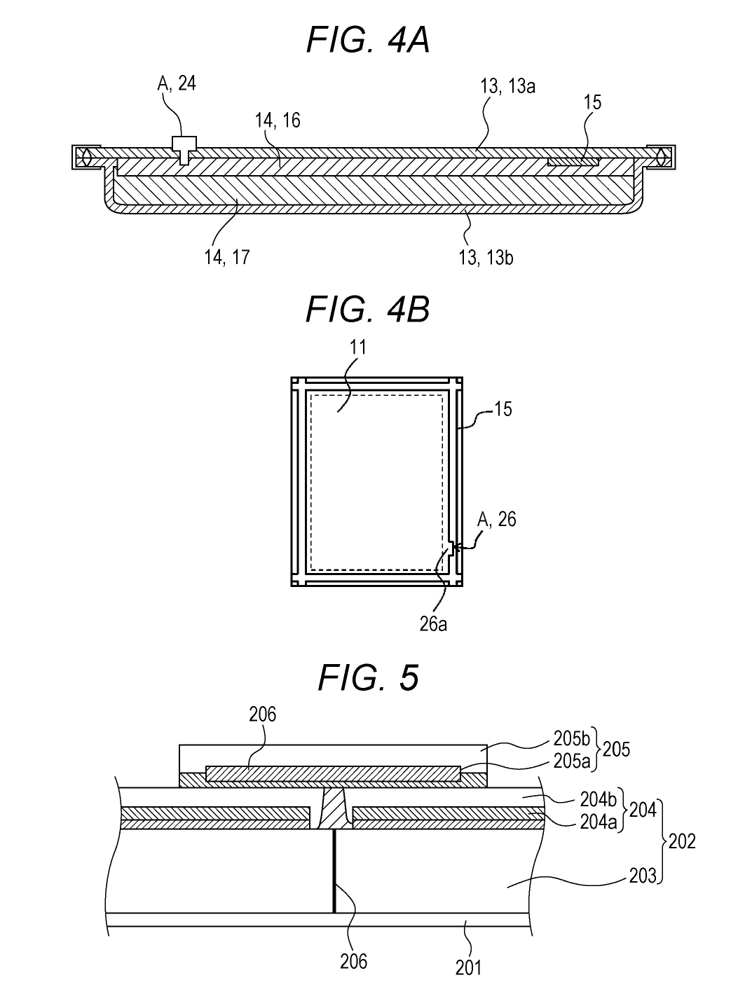

FIG. 4A is a schematic cross-sectional view illustrating one example of an explosion-proof structure of the vacuum heat insulator according to the second exemplary embodiment of the present invention. FIG. 4B is a schematic plan view illustrating another example of the explosion-proof structure of the vacuum heat insulator according to the second exemplary embodiment of the present invention.

In FIG. 4A and FIG. 4B, explosion-proof structure A is implemented in outer wrapping material 13 of vacuum heat insulator 10. This allows that, when the residual gas expands in the inside of outer wrapping material 13, the residual gas is released to an outside when a pressure of the residual gas reaches a predetermined pressure or higher. This prevents damages to outer wrapping material 13 and the like caused by sudden and rapid abnormal deformation of vacuum heat insulator 10. Therefore, safety is enhanced.

A construction and effects other than explosion-proof structure A are same as in the first exemplary embodiment. Same parts as in the first exemplary embodiment will be denoted with same reference numerals, and description thereof will be omitted, so that only different parts will be described.

This explosion-proof structure A is not particularly limited in the structure thereof; however, representatively, there are the following two, for example. A first construction example is a construction in which outer wrapping material 13 reduces expansion by letting the residual gas escape to the outside. A second construction example is a construction in which gas adsorption material 15 that is enclosed together with core material 14 in the inside of outer wrapping material 13 is of a chemical adsorption type that chemically adsorbs the residual gas, a non-heat-generating type that does not generate heat by adsorption of the residual gas, or both a chemical adsorption type and a non-heat-generating type.

First, explosion-proof structure A of the first construction example will be described with reference to FIG. 4A and FIG. 4B.

Representatively, explosion-proof structure A of the first construction example may be, for example, check valve 24 as shown in FIG. 4A or an expansion reducing part made of reduced-strength site 26 as shown in FIG. 4B.

FIG. 4A shows an example of an expansion reducing part (explosion-proof structure A) formed of check valve 24. Check valve 24 has a cap-shaped configuration that closes a valve hole disposed in a part of outer wrapping material 13. The valve hole is disposed to penetrate from an inside to an outside of outer wrapping material 13. Cap-shaped check valve 24 is made of an elastic material such as a rubber.

Typically, the valve hole is in a state of being closed by check valve 24, so that penetration of outside air into the inside of outer wrapping material 13 is substantially prevented. Even when outer wrapping material 13 contracts due to temperature change in surroundings and an inner diameter of the valve hole changes in accordance therewith, check valve 24 can advantageously close the valve hole because check valve 24 is made of an elastic material. As a rare case, when the residual gas expands in the inside of outer wrapping material 13, check valve 24 is easily dislocated from the valve hole along with rise in the internal pressure, so that the residual gas is let to escape to the outside.

In addition, FIG. 4B shows an example of an expansion reducing part (explosion-proof structure A) including reduced-strength site 26. Reduced-strength site 26 is made of site 26a obtained by reducing a welded area of a part of a welded site between the metal thin plates. In this reduced-strength site 26, the welded area is smaller than that of other welded sites. As a rare case, when the residual gas expands in the inside of outer wrapping material 13, the pressure caused by rise in the internal pressure is concentrated on reduced-strength site 26. This allows that site 26a obtained by reducing the welded area of the thermally welded site is peeled off, so that the residual gas is let to escape to the outside.

Reduced-strength site 26 may be formed, for example, by applying a smaller heat to a part of the metal thin plate in welding the metal thin plate so as to weaken a degree of welding of the welded site. Alternatively, reduced-strength site 26 may be provided at a position other than the welded site. For example, a site having a partially reduced strength may be formed in a part of outer wrapping material 13 so as to provide a reduced-strength site.

In the present exemplary embodiment, when an accident or the like occurs as a rare case, there is a fear that vacuum heat insulator 10 may be exposed to a severe environment. However, in this case, when the residual gas in the inside undergoes expansion or the like by exposure of vacuum heat insulator 10 to the severe environment, check valve 24 is dislocated from the valve hole, or an excessive expansion pressure is released from reduced-strength site 26 to the outside. This allows that the deformation of outer wrapping material 13 can be effectively evaded. Therefore, the explosion-proof property of vacuum heat insulator 10 can be improved to enhance the safety of the heat-insulating vessel.

Meanwhile, provision of an adsorption material made of a ZSM-5 type zeolite already described may be mentioned as an example of explosion-proof structure A of the second construction example. This ZSM-5 type zeolite constituting the adsorption material is a gas adsorption material having a chemical adsorption function. Therefore, when there are various environmental factors such as temperature rise, for example, the ZSM-5 type zeolite substantially prevents re-releasing of once adsorbed gas. Therefore, when gas adsorption material 15 adsorbs a combustible gas due to an influence of some sort in handling a combustible fuel or the like, the gas is not re-released due to an influence of temperature rise or the like that occurs thereafter. Moreover, the ZSM-5 type zeolite is a non-combustible gas adsorption agent and hence does not generate heat or the like even when the ZSM-5 type zeolite adsorbs a combustible gas. As a result of this, a degree of vacuum in the inside of vacuum heat insulator 10 can be maintained at a good level. Moreover, deformation of vacuum heat insulator 10 due to expansion of the residual gas in the inside of outer wrapping material 13 can also be effectively prevented. Therefore, the explosion-proof property and the stability of vacuum heat insulator 10 can be improved with certainty.

In addition, when gas adsorption material 15 is a non-heat-generating material, a non-combustible material, or a material satisfying both of these properties, gas adsorption material 15 is prevented from generating heat or burning even when a foreign substance penetrates into the inside due to damages of outer wrapping material 13 or the like. Therefore, the explosion-proof property and the stability of vacuum heat insulator 10 can be further improved.

In heat insulator 10 of the present exemplary embodiment, outer wrapping material 13 may have explosion-proof structure A. This allows that, even when a gas remaining in the cells of the heat-insulating core material comes out with lapse of time to raise the internal pressure in the inside of outer wrapping material 13, explosive destruction caused by this internal pressure can be prevented. In addition, heat insulator 10 having high safety can be provided.

In addition, explosion-proof structure A may be made of an expansion reducing part that lets the gas in the inside of outer wrapping material 13 escape to the outside. This allows that, even when the residual gas expands in the inside of outer wrapping material 13 to raise the internal pressure, the internal pressure is let to escape through the expansion reducing part to the outside. Therefore, the explosion-proof property and the stability of the heat insulator can be further improved.

In addition, explosion-proof structure A may contain gas adsorption material 15 that is sealed in the inside of outer wrapping material 13, and gas adsorption material 15 may be gas adsorption material 15 of chemical adsorption type that chemically adsorbs a gas or gas adsorption material 15 of a non-heat-generating type that does not generate heat by adsorption of a gas. This allows that, when gas adsorption material 15 is of the chemical adsorption type, the adsorbed residual gas is not easily eliminated as compared with gas adsorption material 15 of the physical adsorption type, so that the degree of vacuum in the inside of outer wrapping material 13 can be maintained at a good level. Moreover, because the residual gas is not eliminated, the fear that heat insulator 10 may be deformed due to expansion of the residual gas in the inside of outer wrapping material 13 can be effectively prevented. Therefore, the explosion-proof property and the stability of heat insulator 13 can be improved. In addition, when gas adsorption material 15 is a non-heat-generating material, a non-combustible material, or a material satisfying both of these properties, the fear that gas adsorption material 15 may generate heat or burn can be evaded even when a foreign substance penetrates into the inside due to damages of outer wrapping material 13 or the like. Therefore, the explosion-proof property and the stability of heat insulator 10 can be further improved.

### Other Exemplary Embodiments

As described above, the first and second exemplary embodiments can provide a heat insulator having high durability against sea water or the like and having a property such that the thickness of a heat-insulating structure including the heat insulator can be reduced. However, it goes without saying that the present exemplary embodiments can be modified in various ways as long as the object of the present invention is achieved.

For example, in the first and second exemplary embodiments, description has been given by giving as one example a vacuum heat insulator of a heat-insulating vessel for an inboard tank. However, the configuration, the shape, and the like of the vacuum heat insulator and the heat-insulating vessel obtained by using the vacuum heat insulator are not limited to those described above. In other words, the heat-insulating vessel may be, for example, an LNG tank disposed on land, an underground-type LNG tank, a container-type tank, or a box body of a thermostat tank instead of the inboard tank. Further, though an LNG has been exemplified as a substance for heat insulation, the present invention is not limited to an LNG alone, so that the substance for heat insulation may be a substance having a temperature that is at least 100° C. lower than ordinary temperature, for example, a liquefied hydrogen gas.

In addition, though core material 14 is made of two layers including first heat-insulating core material 16 made of an open-cell resin and second heat-insulating core material 17 made of a fiber material, the present invention is not limited to this configuration, so that core material 14 may be made of a single layer of either one of these two layers.

In addition, though description has been given by using an open-cell urethane foam as the open-cell resin, the open-cell resin is not limited to an open-cell urethane foam alone and may be, for example, an open-cell phenolic foam or a copolymer resin containing either one of these. Further, it will be effective when this open-cell resin is an open-cell resin in which cells are formed not only in a core layer but also in a skin layer, as disclosed in Japanese Patent No. 5310928. However, the skin layer of a general open-cell resin in which the skin layer is not made of open cells may be cut off to provide an open-cell resin including only the core layer made of open cells.

In a similar manner, though an inorganic fiber material such as glass wool has been exemplified as the heat-insulating material having a smaller gas permeation resistance than the open-cell resin does, a known organic fiber other than the inorganic fiber may also be used. In addition, a powder material such as perlite may be used as well.

In addition, in each of the exemplary embodiments described above, the ordinary temperature means an atmospheric air temperature.

In this manner, from the description of each of the exemplary embodiments described above, numerous modifications and other exemplary embodiments are apparent to those skilled in the art. Therefore, the description in each of the exemplary embodiments described above should be interpreted only as an exemplification, and is provided for the purpose of teaching those skilled in the art the best modes for carrying out the present invention. In each of the exemplary embodiments described above, the structure and/or the detail of the functions thereof can be substantially changed without departing from the spirit of the present invention.

### INDUSTRIAL APPLICABILITY

As described above, the present invention can provide a heat insulator having high durability against exposure to sea water and a heat-insulating vessel containing the heat insulator. In addition, the present invention can be widely applied to a tank of a transportation tanker for transporting an LNG, a hydrogen gas, or the like.

### REFERENCE MARKS IN THE DRAWINGS

10: heat insulator (vacuum heat insulator)
11: welding
12: cover
13: outer wrapping material
13a: thin flat plate (metal thin plate)
13b: thin concave plate (metal thin plate)
14: core material
15: gas adsorption material (tension relaxing part)
16: first heat-insulating core material
17: second heat-insulating core material
24: check valve (tension relaxing part)
26: reduced-strength site (tension relaxing part)
31: box body
32: foam
100: LNG transportation tanker
110: inboard tank (heat-insulating vessel)
111: ship body (vessel box body)
112: deck
113: primary membrane (first tank)
114: primary heat-proof box (first heat-insulating layer)
115: secondary membrane (second tank)
116: secondary heat-proof box (second heat-insulating layer)
A: explosion-proof structure

1. A heat insulator provided in a heat-insulating vessel for holding a substance having a temperature that is lower than ordinary temperature by at least 100° C., the heat insulator comprising:
a core material; and
an outer wrapping material for wrapping the core material,
wherein the core material has a heat-insulating core material made of an open-cell resin,
the outer wrapping material is made of a metal thin plate,
a peripheral edge of the metal thin plate is fixedly bonded, and
an inside of the outer wrapping material is vacuum-sealed.

2. The heat insulator according to claim 1, wherein the open-cell resin is a thermosetting resin.

3. The heat insulator according to claim 1, wherein the open-cell resin is an open-cell urethane foam, an open-cell phenolic foam, or a copolymer resin containing the open-cell urethane foam or the open-cell phenolic foam.

4. The heat insulator according to claim 1, wherein the outer wrapping material is made of stainless steel or a metal having an ionization tendency equivalent to or lower than an ionization tendency of the stainless steel.

5. The heat insulator according to claim 1, wherein the outer wrapping material has an explosion-proof structure.

6. The heat insulator according to claim 5, wherein the explosion-proof structure is an expansion reducing part for letting a gas in the inside of the outer wrapping material escape to an outside.

7. The heat insulator according to claim 5,
wherein the explosion-proof structure includes a gas adsorption material that is sealed within the outer wrapping material, and
the gas adsorption material is a gas adsorption material of a chemical adsorption type that chemically adsorbs a gas or a non-heat-generating gas adsorption material that does not generate heat by adsorption of a gas.

8. A heat-insulating vessel for holding a substance having a temperature that is lower than ordinary temperature by at least 100° C., comprising the heat insulator according to claim 1.
